(19) United States
(12) Patent Application Publication
(10) Pub. No.: US 2026/0343193 A1
(43) Pub. Date: Oct. 29, 2026

(54) SYSTEMS AND METHODS FOR DETERMINISTIC AND HANDSFREE ENGAGEMENT FOR DATA TRANSFER OF MOBILE IDENTIFICATION AND OTHER DATA

(71) Applicants: HID Global CID SAS, Suresnes (FR); ASSA ABLOY AB, Stockholm (SE)

(72) Inventors: Jean-Baptiste Milan, Jupiter, FL (US); Fabrice Jogand-Coulomb, Aix en Provence (FR); Joseph Bernard Pearson, Cedar Park, TX (US)

(21) Appl. No.: 19/124,382

(22) PCT Filed: Nov. 4, 2022
(86) PCT No.: PCT/IB2022/000795

§ 371 Date: Apr. 25, 2025

(51) Int. Cl. H04W 4/40; H04W 76/14

(52) U.S. Cl. CPC H04W 4/40; H04W 76/14

(57) ABSTRACT

Disclosed herein are systems and methods for deterministic and handsfree engagement for data transfer of mobile identification and other data. In an embodiment, a computer system presents disambiguation data via a user interface, and also broadcasts one or more advertising packets containing the disambiguation data. The computer system establishes a wireless connection with a mobile device. This includes receiving, from the mobile device, at least one message that contains shared-secret data that is based on the disambiguation data. The computer system receives, from the mobile device via the established wireless connection, a mobile driver's license (mDL) of a user of the mobile device.

### TECHNICAL FIELD

Among other technical fields, embodiments of the present disclosure pertain to electronic verification of identity, wireless communication (e.g., Bluetooth Low Energy (BLE)), device disambiguation, device engagement, and, more particularly, to systems and methods for deterministic and handsfree engagement for data transfer of mobile identification and other data.

### BACKGROUND

There are numerous scenarios in modern society in which a person may need or want to present a valid form of identification. Such a presentation could be to a government official (e.g., a law-enforcement officer), an employee of a company (e.g., a customer-service agent at an airport, a bouncer at a nightclub, etc.), or some other example. Additionally, there are many instances in which people are asked to present a valid form of identification to an automated system (e.g., a kiosk at an airport or train station). Many times, such valid forms of identification are issued by a government (e.g., a passport, a state driver's license, and the like). Other times, such valid forms of identification are issued by an employer (e.g., a bank, defense contractor, engineering company, etc.). And certainly other institutions (e.g., universities) issue valid forms of identification as well.

Furthermore, it is becoming increasingly prevalent that one or more forms of identification document carried by a given person are in the form of electronic or digital identification. These digital ID documents are often stored on the person's mobile device. In the case of a driver's license, the electronic version is often referred to as a mobile driver's license (mDL). A given mDL may be presentable by a certain app on a smartphone or as a “card”′ in a “wallet” on a smartphone, among other possibilities. In many cases, drivers that carry an mDL that is stored on (or accessible by) their mobile device do not also carry a physical card, though some carry both.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts a first example roadside-stop scenario, in accordance with at least one embodiment.

FIG. 2 depicts a second example roadside-stop scenario, in accordance with at least one embodiment.

FIG. 3 depicts an example information-flow diagram, in accordance with at least one embodiment.

FIG. 4 depicts a first example officer-system screenshot, in accordance with at least one embodiment.

FIG. 5 depicts a first example driver-device screenshot, in accordance with at least one embodiment.

FIG. 6 depicts a second example driver-device screenshot, in accordance with at least one embodiment.

FIG. 7 depicts a third example driver-device screenshot, in accordance with at least one embodiment.

FIG. 8 depicts a second example officer-system screenshot, in accordance with at least one embodiment.

FIG. 9 depicts a fourth example driver-device screenshot, in accordance with at least one embodiment.

FIG. 10 depicts a third example officer-system screenshot in accordance with at least one embodiment.

FIG. 11 depicts an example method, in accordance with at least one embodiment.

FIG. 12 depicts an example computer system that could be configured to perform at least one embodiment and/or embody one or more devices, systems, and/or the like, in accordance with at least one embodiment.

FIG. 13 depicts an example software architecture that could be implemented on a computer system such as the example computer system of FIG. 12, in accordance with at least one embodiment.

### DETAILED DESCRIPTION

In the field of digital IDs, there are several standards that have been promulgated by an organization known as the International Standardization Organization, or ISO for short. Moreover, a number of these standards are developed via collaboration between ISO and another organization known as the International Electrotechnical Commission (IEC). Two such series of these standards are the ISO/IEC 18013 series and the ISO/IEC 23220 series.

Included in the former is a standard called “ISO/IEC 18013-5: Personal Identification—ISO-Compliant Driving License—Part 5: Mobile Driving License (MDL) Application.” Included in the latter is a standard (currently under development) called “ISO/IEC 23220-4: Cards and Security Devices for Personal Identification—Building Blocks for Identity Management via Mobile Devices—Part 4: Protocols and Services for Operational Phase.”

Generally speaking, according to these standards, a law-enforcement officer making a roadside stop of a driver may carry a scanning device up to the driver's side of the car.

When presented by the driver with the driver's mDL on the driver's mobile device, the officer may scan a quick response (QR) code displayed on the mobile device in connection with the mDL. In some other instances, the officer's scanning device may connect with the driver's mobile device via what is known as near-field communication (NFC). Other current implementations use a BLE scanning device to attempt to connect to the driver's mobile device based on distance as determined by the (non-directional) BLE communication.

These implementations have drawbacks. For example, the QR-code and NFC implementations both require the officer to approach the vehicle with a scanning device in one hand. This limits the officer's ability to draw their weapon (e.g., gun, taser, etc.) and/or react in some other way in the undesirable event that such actions or reactions become necessary. Moreover, the above-described non-directional BLE implementation is not deterministic when it comes to the officer's computing system connecting wirelessly with the driver's mobile device. Indeed, depending on the situation, the officer system may connect to the mobile device of another officer, the mobile device of another driver, the mobile device of a passenger in the pulled-over vehicle, the mobile device of a pedestrian, and/or the like.

In the above-described QR-code, NFC, and non-directional-BLE implementations, as well as in other current implementations, the initiation of a connection between the driver's mobile device on the one hand and the officer's handheld device, vehicle-based system, or the like on the other hand is known as “engagement.” After successful engagement, a secure connection may be negotiated between the driver's mobile device and the officer system. (The term “officer system” is used in the present disclosure to encompass handheld implementations, vehicle-based implementations, and so forth.)

Once the secure connection is established, the driver's mDL can be securely transmitted over the secure connection from the driver's mobile device to the officer system. In some cases, data such as a secure token is transmitted from the driver's mobile device to the officer system, and the officer system then uses that secure token (possibly along with additional data that may also come from the driver's mobile device or from elsewhere) to retrieve the driver's mDL from a networked server. Other implementations are possible as well. In some cases, the driver's mobile device also provides a uniform resource locator (URL) or other unique identifier of an authorized identity-issuing organization (e.g., a state government), and the officer system uses that information to navigate to the correct system for retrieval of the mDL using the secure token.

To address at least the above-described issues with some prior implementations, disclosed herein are embodiments of systems and methods for deterministic and handsfree engagement for data transfer of mobile identification and other data. The deterministic nature of embodiments of the present disclosure helps ensure that the officer system establishes a connection with the correct mobile device—i.e., that of the driver of the pulled-over vehicle-for transmission of the correct mDL to the officer system. Moreover, the handsfree nature of embodiments of the present disclosure make such situations safer for the officer and the driver, in that both of the officer's hands are free to take any necessary action. The law-enforcement agency also saves money by not having to purchase and manage dedicated scanning devices for the officers.

In some embodiments, an officer may initially approach the vehicle and tell the driver certain information (or, e.g., tell the driver to expect the communication of certain information). In most of the examples described in the present disclosure, that information takes the form of a 4-digit code. In an example embodiment, a loudspeaker may convey the 4-digit code one or more times. In another example, a visual display on the officer's vehicle may display the 4-digit code. The officer may simply read the code from their vehicle-based system and then go tell the code to the driver. In some embodiments, the officer may enter (e.g., key in) a 4-digit code selected by the officer into the officer system, which may then display that entered code.

However the driver obtains the 4-digit code, the driver may then open the appropriate ID-management app on their smartphone, and indicate in some manner that the driver wishes to connect their mobile device app with the officer system. The driver may indicate this in a number of different ways. In one example, the driver may tap on “Search for Connections” button or the like. This may result in the app prompting the driver to enter a 4-digit code, at which point the driver may enter the 4-digit code that was conveyed in some manner to the driver by the officer and/or the officer system.

As a result of entry of the code, the driver's mobile device and the officer system may establish a wireless connection between them. In at least one embodiment, the driver's mobile device and the officer system establish a BLE connection between them. This could happen in a number of different ways. In some embodiments, the officer system broadcasts one or more advertising packets that contain the 4-digit code. In other embodiments, the driver's mobile device broadcasts one or more advertising packets that contain the 4-digit code. Furthermore, whether the advertising packets come from the officer system or from the driver's mobile device, the advertising packets may include one or more values derived from the 4-digit code instead of the code itself. Other implementations are possible as well.

Assuming by way of example that the officer system is transmitting the advertising packets, the driver's mobile device (e.g., the above-described app) may then respond and engage in messaging (e.g., handshaking) in order to set up a secure BLE connection with the officer system. This may include transmitting cryptographic keys (e.g., ephemeral session keys) and/or one or more other values. Once the secure connection is established, the driver may next indicate in some manner that the driver wishes to share their mDL with the officer (i.e., with the officer system). The driver may indicate this in a number of different ways. As one example, the driver may select (e.g., tap on) the mDL among a group of IDs, and then tap a “share” button with the mDL selected. The mDL may then be securely transferred from the driver's mobile device to the officer system, on which a complementary app may be running. That complementary app may be from the same developer or be otherwise compatible according to an agreed-upon interface.

One embodiment takes the form of a method that is performed by a computer system executing instructions on at least one hardware processor. This example embodiment is performed by an officer system. In the method, the officer system presents disambiguation data (e.g., a 4-digit code) via a user interface of the officer system. The officer system also broadcasts one or more advertising packets containing shared-secret data, which could be the disambiguation data itself, or data derived therefrom. The officer system establishes a secure wireless connection with a mobile device (e.g., a driver's mobile device), and thereafter receives a an mDL over the secure wireless connection from the mobile device. The mDL is uniquely associated with a user of the mobile device to which the officer system is connected.

As described herein, one or more embodiments of the present disclosure take the form of methods that include multiple operations. One or more other embodiments take the form of systems that include at least one hardware processor and that also include one or more non-transitory computer-readable storage media containing instructions that, when executed by the at least one hardware processor, cause the at least one hardware processor to perform multiple operations (that in some embodiments do and in other embodiments do not correspond to operations performed in a herein-disclosed method embodiment). Still one or more other embodiments take the form of one or more non-transitory computer-readable storage media (CRM) containing instructions that, when executed by at least one hardware processor, cause the at least one hardware processor to perform multiple operations (that, similarly, in some embodiments do and in other embodiments do not correspond to operations performed in a herein-disclosed method embodiment and/or operations performed by a herein-disclosed system embodiment).

Furthermore, a number of variations and permutations of embodiments are described herein, and it is expressly noted that any variation or permutation that is described in this disclosure can be implemented with respect to any type of embodiment. For example, a variation or permutation that is primarily described in this disclosure in connection with a method embodiment could just as well or instead be implemented in connection with a system embodiment and/or a CRM embodiment. Furthermore, this flexibility and cross-applicability of embodiments is present in spite of any slightly different language (e.g., processes, methods, methodologies, steps, operations, functions, and/or the like) that is used to describe and/or characterize such embodiments and/or any element or elements thereof.

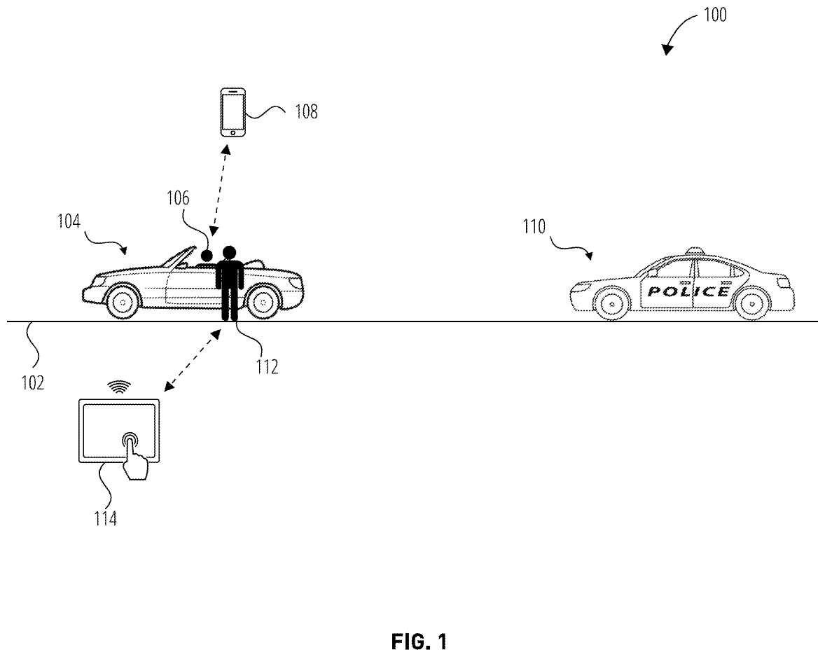

One context in which embodiments of the present disclosure may be utilized is that of roadside stops of vehicles by law-enforcement officers. FIG. 1 depicts an example roadside-stop scenario 100. As can be seen in FIG. 1, a driver vehicle 104 has been pulled over by an officer 112 using a police vehicle 110. Both are shown as stopped on a street 102. FIG. 1 depicts a scenario in which the officer 112 has to carry an officer ID-scanning device 114 up to the side of the driver vehicle 104 that is driven by a driver 106. The officer 112 may use the officer ID-scanning device 114 to scan a QR code on, or engage in NFC communication with, a driver mobile device 108 of the driver 106. The mDL of the driver 106 may be stored on the driver mobile device 108. As described above, this arrangement is less than ideal for reasons including convenience and safety.

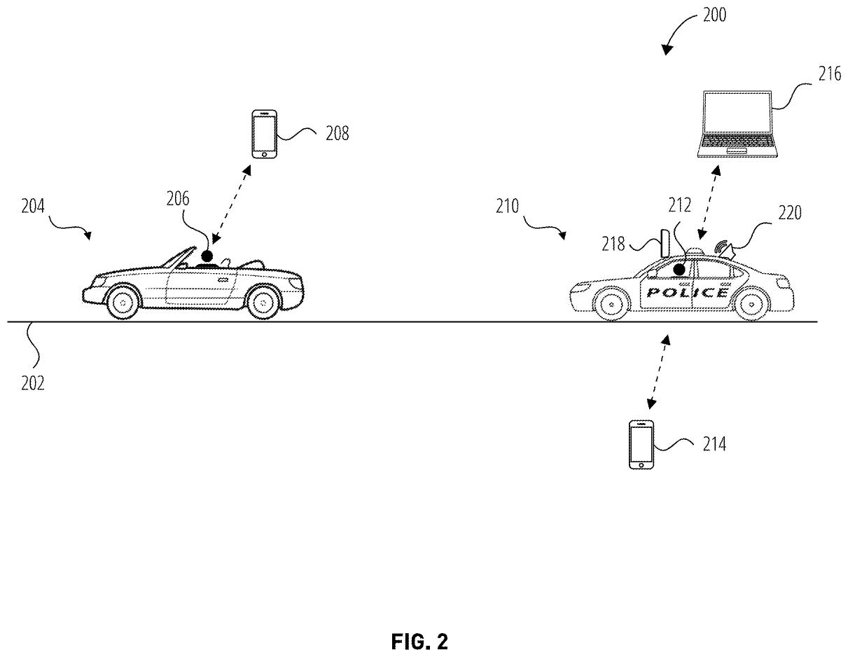

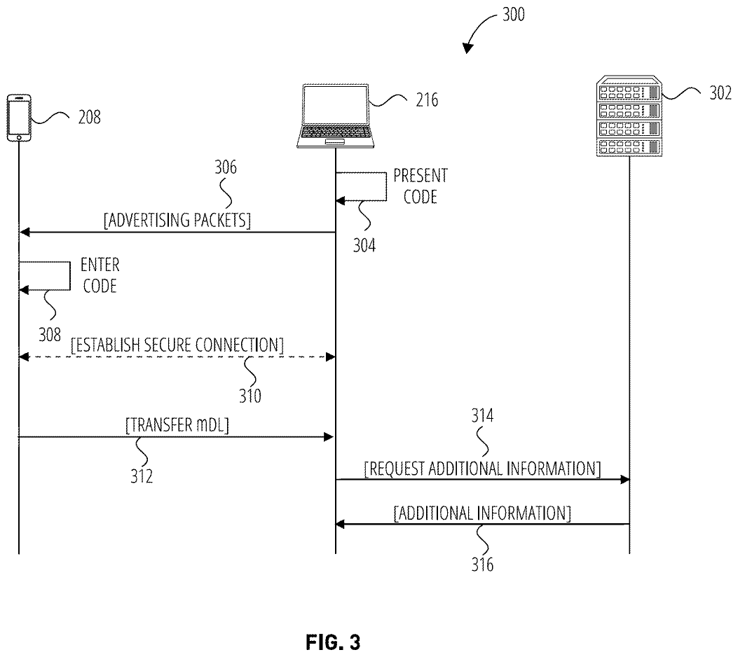

FIG. 2 depicts an example roadside-stop scenario 200, in accordance with at least one embodiment. In the example roadside-stop scenario 200, there is again a street 202 on which a driver 206 that is driving a driver vehicle 204 has been pulled over by an officer 212 that is driving a police vehicle 210. In this scenario, the driver 206 has an associated driver mobile device 208. Incidentally, the officer 212 may also have an officer mobile device 214, though that device is not referred to again in the present example that is further described below in connection with FIG. 3 through FIG. 10.

It can be seen in FIG. 2 that the police vehicle 210 is equipped with an officer system 216, a display 218, and a loudspeaker 218. In some embodiments, neither the display 218 nor the loudspeaker 220 is present. In some embodiments, one but not both is present. In the example embodiments that are primarily described herein, both the display 218 and the loudspeaker 220 are present. Either or both of the display 218 and the loudspeaker 220 could, if present, be positioned inside or outside the police vehicle 210.

FIG. 3 depicts an example information-flow diagram 300, in accordance with at least one embodiment. This example information flow is presented by way of example, and different messaging flows and functions could be used in different embodiments. As can be seen in FIG. 3, the three entities that are performing the described functions and engaging in the described messaging are the driver mobile device 208 and the officer system 216 from FIG. 2, as well as an mDL database server 302. In an embodiment, the officer system 216 and the mDL database server 302 can securely communicate with one another using suitable encryption protocols.

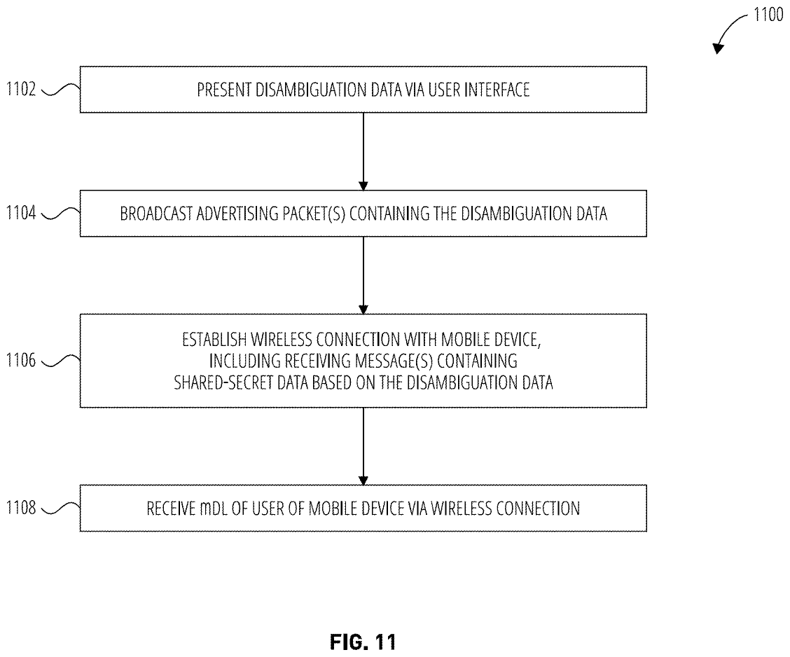

The first operation carried out in the information-flow diagram 300 is a code presentation 304 that is performed by the officer system 216. As described below in connection with the corresponding operation 1102 of the method 1100 that is depicted in FIG. 11, at the code presentation 304, the officer system 216 may display disambiguation data on its own screen, it may display the disambiguation data on the display 218, and/or it may audibly play out the disambiguation data one or more times via the loudspeaker 220.

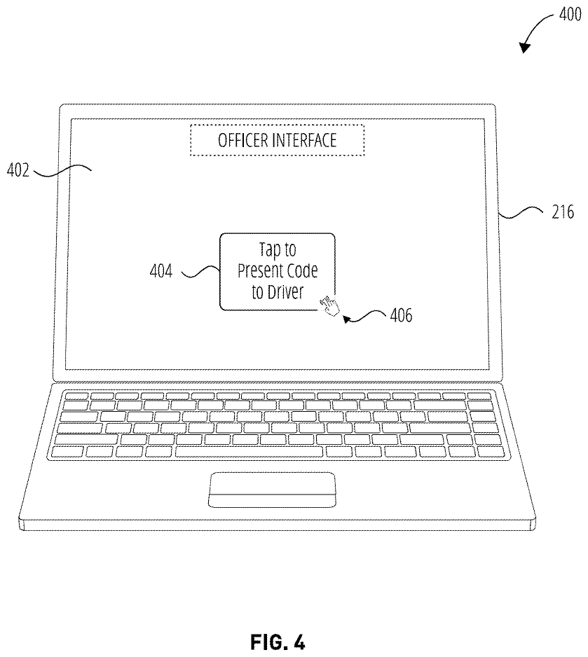

In the example described here, the disambiguation data is a 4-digit code. FIG. 4 shows an example officer-system screenshot 400 that could be displayed on the officer system 216. As shown the officer system 216 could present an officer interface 402 to the officer 212, including a present-code button 404 that the officer 212 could actuate with a tap 406. It is further noted that the officer system 216 also begins transmitting advertising packets 306 that are receivable by the driver mobile device 208. The broadcasting of the advertising packets 306 corresponds with operation 1104 of FIG. 11.

It is understood but not explicitly depicted in FIG. 3 that the driver 206 somehow finds out what the 4-digit code is, whether by being told by the officer 212, seeing the code on the display 218, hearing the code from the loudspeaker 220, and/or the like. The next operation that takes place is a code entry 308, which involves the driver mobile device 208 receiving entry of the 4-digit code from the driver 206 via a user interface of the driver mobile device 208.

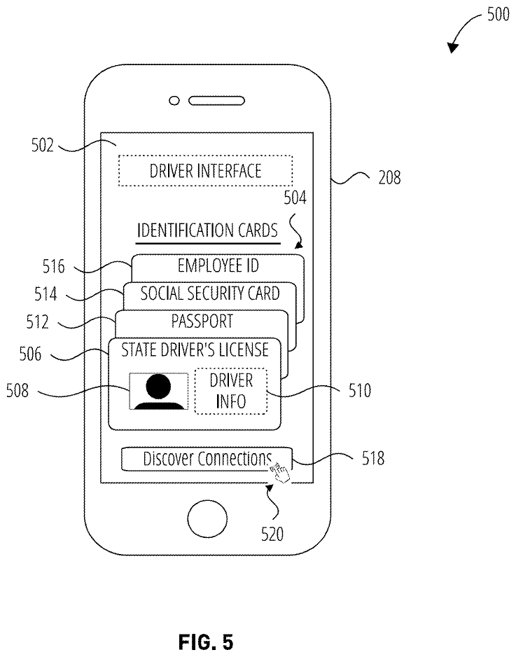

As shown in FIG. 5, the driver mobile device 208 may present an example driver-device screenshot 500. The driver-device screenshot 500 depicts a screen of the driver mobile device 208 at a time prior to the driver 206 entering the 4-digit code. As an example, the driver 206 may have just learned the 4-digit code as described above. In FIG. 5, the driver mobile device 208 is presenting a driver interface 502 that includes a set of identification cards 504. By way of example, the depicted set of identification cards 504 includes a mDL 506 (having a picture 508 and driver information 510), a passport 512, a social-security card 514, and an employee ID 516.

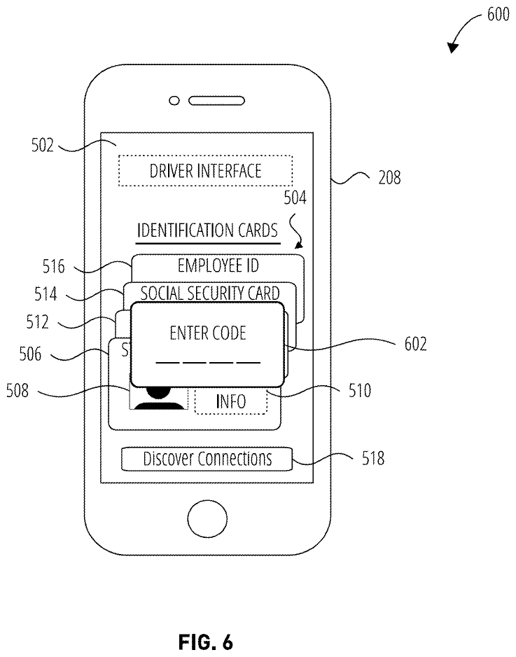

Also depicted on the driver-device screenshot 500 is a discover-connections button 518 that the driver 206 can actuate with a tap 520. Doing so may present on the driver mobile device 208 the example driver-device screenshot 600 that is shown in FIG. 6. All of the same elements are present in FIG. 6 as in FIG. 5, with an overlay of a code-entry window 602 also displayed. The code-entry window 602 represents a user-interface element via which the 4-digit code can be received by the driver mobile device 208.

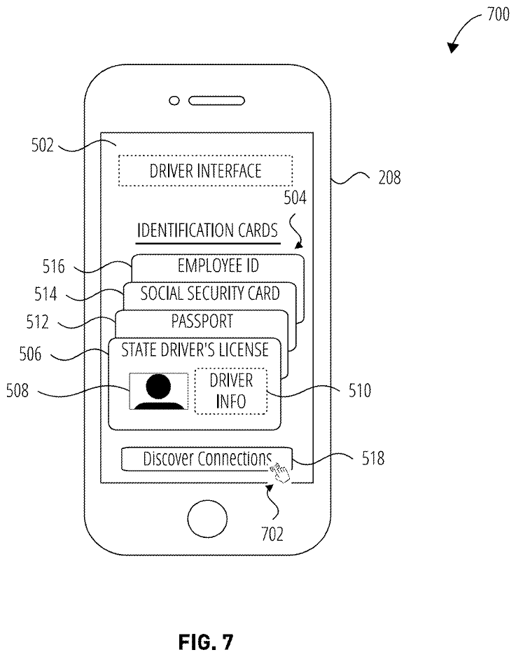

After entry of the correct code into the code-entry window 602, the driver 206 may be presented with the example driver-device screenshot 700 that is shown in FIG. 7. At that point, the driver 206 may actuate the discover-connections button 518 with a tap 702. In at least one embodiment, the code entry 308 of the correct 4-digit code into the code-entry window 602 and the actuation of the discover-connections button 518 results in a connection establishment 310 occurring between the officer system 216 and the driver mobile device 208. By virtue of the correct code having been entered into the code-entry window 602 and advertising packets 306 also including the correct code, the driver mobile device 208 can operate its BLE interface to proceed with secure-connection establishment with the officer system 216.

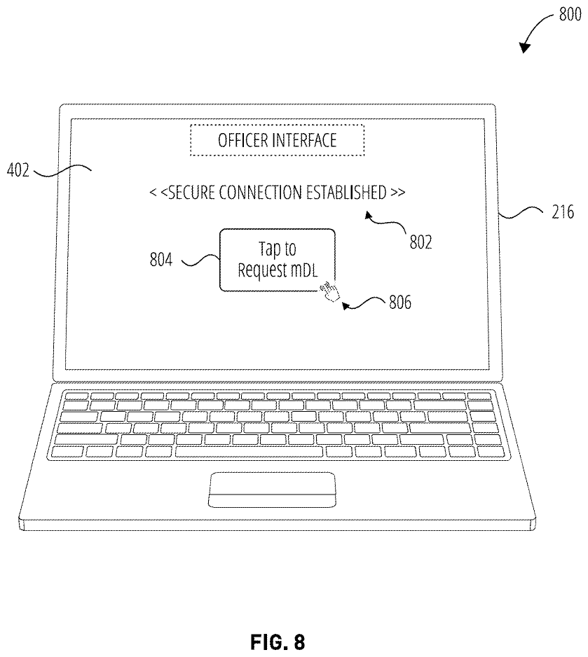

Following the connection establishment 310, a mDL transfer 312 takes place in which the mDL 506 of the driver 206 is securely transmitted from the driver mobile device 208 to the officer system 216. In at least one embodiment, the mDL transfer 312 takes place responsive to two events. First, in at least one embodiment, there is an input entered by the officer 212 on the example officer-system screenshot 800 that is shown in FIG. 8. In the officer-system screenshot 800, a status message 802 appears on the officer interface 402, indicating that the connection establishment 310 has been successfully carried out. In addition to displaying the status message 802, the officer system 216 may also display a request-mDL button 804, which the officer 212 can actuate with a tap 806.

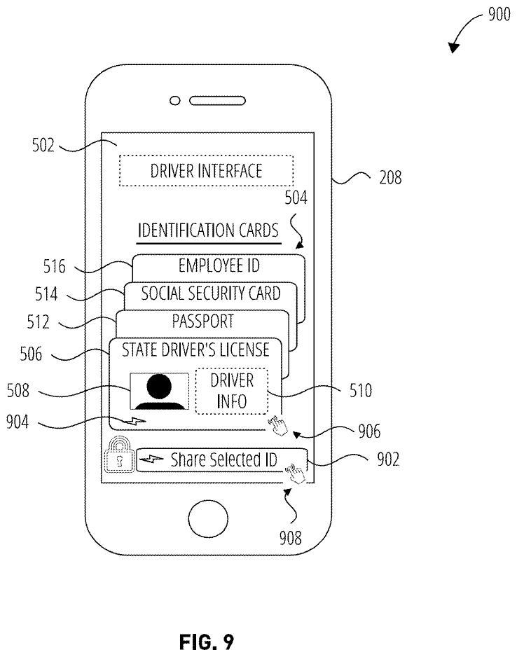

Second, in at least one embodiment, there is an input entered by the driver 206 on the example driver-device screenshot 900 that is shown in FIG. 9. As can be seen in the example of FIG. 9, a first tap 906 results in the mDL 506 becoming selected, as shown in FIG. 9 by a transfer icon 904. It is also noted that the existence of the secure connection is indicated in FIG. 9 by a lock icon in the lower-left corner of the driver interface 502. After selecting the mDL 506, a second tap 908, this one on a share button 902, signals the consent of the driver 206 to transfer the mDL 506 to the officer system 216.

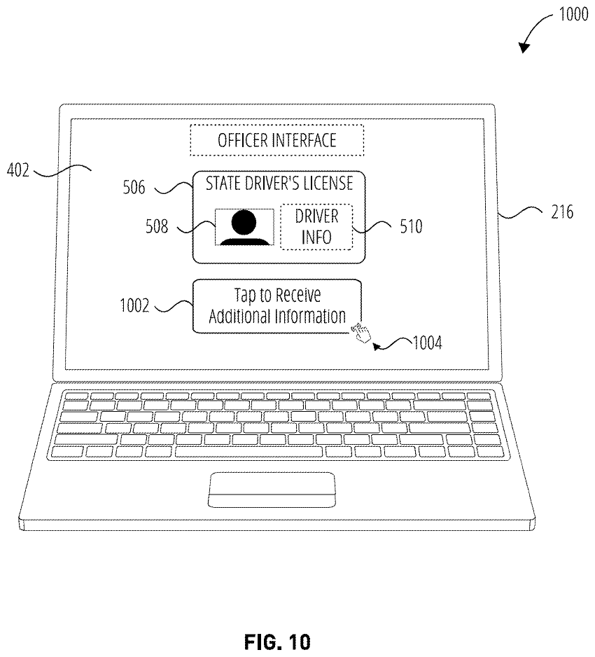

Following the mDL transfer 312, the officer system 216 may present an example officer-system screenshot 1000 that is shown in FIG. 10. On the officer-system screenshot 1000, the mDL 506 is displayed. In at least one embodiment, also displayed on the 1000 is an additional-information button 1002 that can be actuated with a tap 1004. This may result in the additional-information request 314 and the additional-information response 316 that are depicted in FIG. 3 between the officer system 216 and the mDL database server 302. Additional information could include the full driving record of the driver 206, any outstanding warrants, any warnings or notes from previous encounters between the driver 206 and the officer 212 or another officer, and/or the like.

It can therefore be seen that, by operation of embodiments of the present disclosure, an engagement for purposes of transferring an mDL can be conducted in a manner that is handsfree and determinative. The engagement is handsfree in the sense of the officer 212 not having to walk up to the driver vehicle 104 holding an officer ID-scanning device 114 in one hand. Obviously the officer 212 may use their hands, a stylus, or what have you to tap on the various screens presented on the officer system 216. The engagement is deterministic in that the conveyance to-and subsequent entry by-the driver 206 of the 4-digit code results in there being no ambiguity as to which two devices should be establishing a secure connection with one another.

FIG. 11 depicts an example method 1100, in accordance with at least one embodiment. By way of example, the method 1100 is described here as being carried out by an officer system (e.g., the officer system 216). This is by way of example and not limitation, as the method 1100 could be carried out by any one or combination of devices, systems, and/or the like that are suitably equipped, programmed, and configured to perform the described operations.

At operation 1102, the officer system presents disambiguation data via a user interface. In at least one embodiment, the disambiguation data includes (or is) a numeric code. Another option is that the disambiguation data could include an alphanumeric code. With respect to presenting the disambiguation data via the user interface, this could be or include displaying the disambiguation data on a screen of the officer system. In such an embodiment, an officer may simply read the code off the screen, and then walk up and tell the driver the code to enter. Another option is that the officer system may display the disambiguation data on a screen that is visible outside the vehicle. The screen could be inside or outside the vehicle. The officer system may audibly output the disambiguation data such that the disambiguation data is audible outside the vehicle. An associated loudspeaker could be inside or outside the vehicle. Any combination of these approaches, as well as others, could also be used.

At operation 1104, the officer system scans for advertising packages containing the disambiguation data or alternatively broadcasts one or more advertising packets containing the disambiguation data. In the embodiments in which the disambiguation data is a 4-digit code, each advertising packet may have that 4-digit code in a predetermined field (e.g., an Ident characteristic). In non-BLE implementations, a data field such as a Wi-Fi passphrase could be used. And certainly many other examples could be listed here.

At operation 1106, the officer system establishes a wireless connection (e.g., a secure wireless connection) with a mobile device (or alternatively the mobile device establishes connection). The establishing of the wireless connection with the mobile device may include receiving, from the mobile device, at least one message that contains shared-secret data that is based on the disambiguation data. In some cases, the shared-secret data includes the disambiguation data. In some cases, the shared-secret data includes data derived from the disambiguation data. In some embodiments, the disambiguation data is used by the mobile station to select the officer system to connect to, but the mobile station does not send any messages that include the disambiguation data back to the officer system.

At operation 1108, the officer system receives, from the mobile device via the established wireless connection, an mDL of a user of the mobile device. In some embodiments, the officer system resides in a first vehicle (e.g., a law-enforcement vehicle), and the mDL that is transferred is the mDL of a driver of a second vehicle (where the aforementioned mobile station is the mobile station of that driver). It is further noted that the mobile station need not be just a smartphone, but could instead or in addition be or include a smartwatch, a wearable, and/or the like. In at least one embodiment, the mDL is maintained in a secure element in the mobile station. That secure element could be or include an embedded universal integrated circuit card (eUICC), an embedded secure element (eSE), a Trusted Execution Environments (TEE), and/or the like.

It is further noted that, although most of the examples described herein involve the officer system sending out the advertising packets, it could instead be the mobile station that does so. As a general matter, the processes and messaging described herein could be conducted with the officer system or the mobile station playing either role. In the terminology of BLE, the officer system could be in BLE central mode and the mobile device in BLE peripheral mode, or vice versa. When operating in BLE central mode, a system such as the officer system may be referred to by those in the art as an “mDL Reader.”

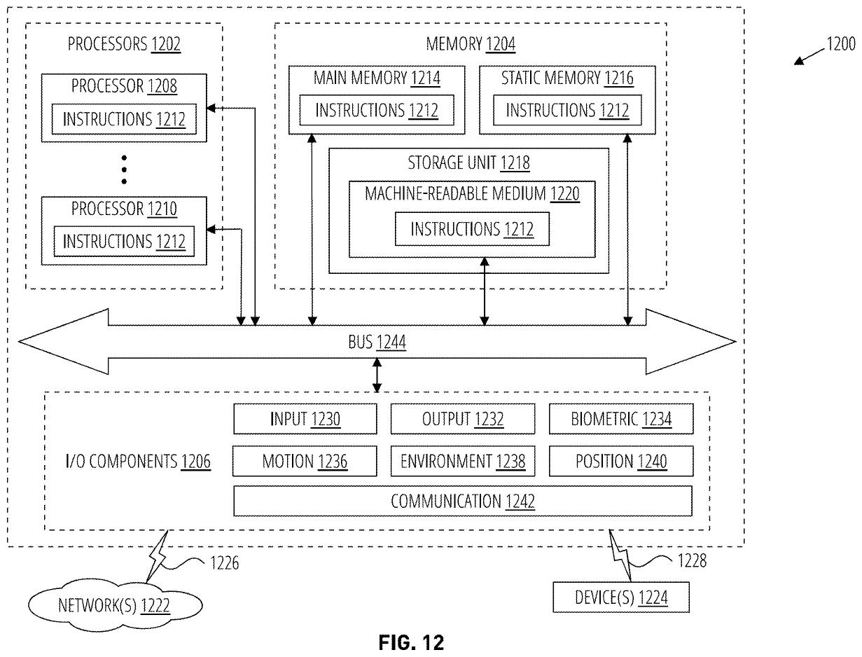

FIG. 12 depicts an example computer system 1200 that could be utilized to embody and/or perform at least one embodiment, and within which instructions 1212 (e.g., software, a program, an application, an applet, an app, and/or other executable code) may be executed to cause the computer system 1200 to perform any one or more of the methodologies discussed herein. For example, execution of the instructions 1212 may cause the computer system 1200 to perform any one or more of the methods described herein. The instructions 1212 transform the general, non-programmed computer system 1200 into a particular computer system 1200 programmed to carry out the described and illustrated functions in the manner described. The computer system 1200 may operate as a standalone device or may be coupled (e.g., networked) to other machines. In a networked deployment, the computer system 1200 may operate in the capacity of a server machine or a client machine in a server-client network environment, or as a peer machine in a peer-to-peer (or distributed) network environment.

The computer system 1200 may be or include, but is limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, and/or any other machine capable of executing the instructions 1212, sequentially or otherwise, that specify actions to be taken by the computer system 1200. Further, while only a single computer system 1200 is illustrated, the term “machine” shall also be taken to include a collection of machines that individually or jointly execute the instructions 1212 to perform any one or more of the methodologies discussed herein.

The computer system 1200 may include processors 1202, memory 1204, and I/O components 1206, which may be configured to communicate with each other via a bus 1244. In an example embodiment, the processors 1202 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, and/or any suitable combination thereof) may include, for example, a processor 1208 and a processor 1210 that execute the instructions 1212. The term “processor” is intended to include multi-core processors that may include two or more independent processors (sometimes referred to as “cores”) that may execute instructions contemporaneously. Although FIG. 12 shows multiple processors 1202, the computer system 1200 may include a single processor with a single core, a single processor with multiple cores (e.g., a multi-core processor), multiple processors with a single core, multiple processors with multiples cores, or any combination thereof.

The memory 1204 includes a main memory 1214, a static memory 1216, and a storage unit 1218, each of which is accessible to the processors 1202 via the bus 1244. The memory 1204, the static memory 1216, and/or the storage unit 1218 may store the instructions 1212 executable for performing any one or more of the methodologies or functions described herein. The instructions 1212 may also or instead reside completely or partially within the main memory 1214, within the static memory 1216, within machine-readable medium 1220 within the storage unit 1218, within at least one of the processors 1202 (e.g., within a cache memory of a given one of the processors 1202), and/or any suitable combination thereof, during execution thereof by the computer system 1200. The machine-readable medium 1220 is one or more non-transitory computer-readable storage media.

The I/O components 1206 may include a wide variety of components to receive input, produce and/or provide output, transmit information, exchange information, capture measurements, and/or the like. The specific I/O components 1206 that are included in a particular instance of the computer system 1200 will depend on the type of machine. For example, portable machines such as mobile phones may include a touch input device or other such input mechanisms, while a headless server machine may not include such a touch input device. It will be appreciated that the I/O components 1206 may include many other components that are not shown in FIG. 12.

In various example embodiments, the I/O components 1206 may include output components 1232 and input components 1230. The output components 1232 may include visual components (e.g., a display such as a plasma display panel (PDP), a light emitting diode (LED) display, a liquid crystal display (LCD), a projector, and/or a cathode ray tube (CRT)), acoustic components (e.g., speakers), haptic components (e.g., a vibratory motor, resistance mechanisms), other signal generators, and so forth. The input components 1230 may include alphanumeric input components (e.g., a keyboard, a touchscreen configured to receive alphanumeric input, a photo-optical keyboard, and/or other alphanumeric input components), point-based input components (e.g., a mouse, a touchpad, a trackball, a joystick, a motion sensor, and/or one or more other pointing instruments), tactile input components (e.g., a physical button, a touchscreen that is responsive to location and/or force of touches or touch gestures, and/or one or more other tactile input components), audio input components (e.g., a microphone), and/or the like.

In further example embodiments, the I/O components 1206 may include biometric components 1234, motion components 1236, environmental components 1238, and/or position components 1240, among a wide array of other components. The biometric components 1234 may include components to detect expressions (e.g., hand expressions, facial expressions, vocal expressions, body gestures, eye tracking, and/or the like), measure biosignals (e.g., blood pressure, heart rate, body temperature, perspiration, brain waves, and/or the like), identify a person (by way of, e.g., voice identification, retinal identification, facial identification, fingerprint identification, and/or electroencephalogram-based identification), and/or the like. The motion components 1236 may include acceleration-sensing components (e.g., an accelerometer), gravitation-sensing components, rotation-sensing components (e.g., a gyroscope), etc.

The environmental components 1238 may include, for example, illumination-sensing components (e.g., a photometer), temperature-sensing components (e.g., one or more thermometers), humidity-sensing components, pressure-sensing components (e.g., a barometer), acoustic-sensing components (e.g., one or more microphones), proximity-sensing components (e.g., infrared sensors that detect nearby objects), gas-sensing components (e.g., gas-detection sensors to detection concentrations of hazardous gases for safety and/or to measure pollutants in the atmosphere), and/or other components that may provide indications, measurements, signals, and/or the like that correspond to a surrounding physical environment. The position components 1240 may include location-sensing components (e.g., a global positioning system (GPS) receiver), altitude-sensing components (e.g., altimeters and/or barometers that detect air pressure from which altitude may be derived), orientation-sensing components (e.g., magnetometers), and/or the like.

Communication may be implemented using a wide variety of technologies. The I/O components 1206 may further include communication components 1242 operable to communicatively couple the computer system 1200 to a network 1222 and/or devices 1224 via a coupling 1226 and/or a coupling 1228, respectively. For example, the communication components 1242 may include a network-interface component or another suitable device to interface with the network 1222. In further examples, the communication components 1242 may include wired-communication components, wireless-communication components, cellular-communication components, Near Field Communication (NFC) components, Bluetooth (e.g., Bluetooth Low Energy) components, Wi-Fi components, and/or other communication components to provide communication via one or more other modalities. The devices 1224 may include one or more other machines and/or any of a wide variety of peripheral devices (e.g., a peripheral device coupled via a universal serial bus (USB) connection).

Moreover, the communication components 1242 may detect identifiers or include components operable to detect identifiers. For example, the communication components 1242 may include radio frequency identification (RFID) tag reader components, NFC-smart-tag detection components, optical-reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and/or other optical codes), and/or acoustic-detection components (e.g., microphones to identify tagged audio signals). In addition, a variety of information may be derived via the communication components 1242, such as location via Internet Protocol (IP) geolocation, location via Wi-Fi signal triangulation, location via detecting an NFC beacon signal that may indicate a particular location, and/or the like.

One or more of the various memories (e.g., the memory 1204, the main memory 1214, the static memory 1216, and/or the (e.g., cache) memory of one or more of the processors 1202) and/or the storage unit 1218 may store one or more sets of instructions (e.g., software) and/or data structures embodying or used by any one or more of the methodologies or functions described herein. These instructions (e.g., the instructions 1212), when executed by one or more of the processors 1202, cause various operations to implement various embodiments of the present disclosure.

The instructions 1212 may be transmitted or received over the network 1222, using a transmission medium, via a network-interface device (e.g., a network-interface component included in the communication components 1242) and using any one of a number of well-known transfer protocols (e.g., the Session Initiation Protocol (SIP), the hypertext transfer protocol (HTTP), and/or the like). Similarly, the instructions 1212 may be transmitted or received using a transmission medium via the coupling 1228 (e.g., a peer-to-peer coupling) to the devices 1224.

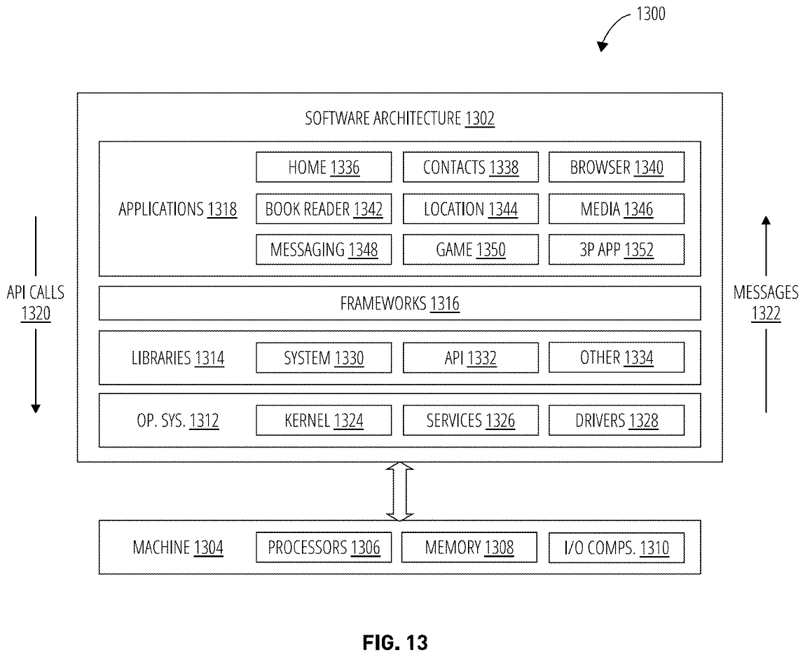

FIG. 13 depicts an example software architecture 1302 that could be executed on the example computer system 1200 of FIG. 12, in accordance with at least one embodiment. The illustrated example software architecture 1302 can be installed on any one or more of the devices described herein. For example, the software architecture 1302 could be installed on any device or system that is arranged similar to the computer system 1200 of FIG. 12. The software architecture 1302 is supported by hardware such as a machine 1304 that includes processors 1306, memory 1308, and I/O components 1310. In this example, the software architecture 1302 can be conceptualized as a stack of layers, where each layer provides a particular functionality. The software architecture 1302 includes layers such an operating system 1312, libraries 1314, frameworks 1316, and applications 1318. Operationally, using one or more application programming interfaces (APIs), the applications 1318 invoke API calls 1320 through the software stack and receive messages 1322 in response to the API calls 1320.

The operating system 1312 manages hardware resources and provides common services. The operating system 1312 includes, for example, a kernel 1324, services 1326, and drivers 1328. The kernel 1324 acts as an abstraction layer between the hardware and the other software layers. For example, the kernel 1324 may provide memory management, processor management (e.g., scheduling), component management, networking, and/or security settings, in some cases among other functionality. The services 1326 can provide other common services for the other software layers. The drivers 1328 are responsible for controlling or interfacing with the underlying hardware. For instance, the drivers 1328 can include display drivers, camera drivers, Bluetooth or Bluetooth Low Energy drivers, flash memory drivers, serial communication drivers (e.g., USB drivers), Wi-Fi drivers, audio drivers, power management drivers, and/or the like.

The libraries 1314 provide a low-level common infrastructure used by the applications 1318. The libraries 1314 can include system libraries 1330 (e.g., a C standard library) that provide functions such as memory-allocation functions, string-manipulation functions, mathematic functions, and/or the like. In addition, the libraries 1314 can include API libraries 1332 such as media libraries (e.g., libraries to support presentation and/or manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG), and/or the like), graphics libraries (e.g., an OpenGL framework used to render in two dimensions (2D) and three dimensions (3D) in graphic content on a display), database libraries (e.g., SQLite to provide various relational-database functions), web libraries (e.g., WebKit to provide web-browsing functionality), and/or the like. The libraries 1314 can also include a wide variety of other libraries 1334 to provide many other APIs to the applications 1318.

The frameworks 1316 may provide a high-level common infrastructure that is used by the applications 1318. For example, the frameworks 1316 may provide various graphical user interface (GUI) functions, high-level resource management, high-level location services, and/or the like. The frameworks 1316 can provide a broad spectrum of other APIs that can be used by the applications 1318, some of which may be specific to a particular operating system or platform.

Purely as representative examples, the applications 1318 may include a home application 1336, a contacts application 1338, a browser application 1340, a book-reader application 1342, a location application 1344, a media application 1346, a messaging application 1348, a game application 1350, and/or a broad assortment of other applications generically represented in FIG. 13 as a third-party application 1352. The applications 1318 are programs that execute functions defined in the programs. Various programming languages can be employed to create one or more of the applications 1318, structured in a variety of manners, such as object-oriented programming languages (e.g., Objective-C, Java, C++, etc.), procedural programming languages (e.g., C, assembly language, etc.), and/or the like. In a specific example, the third-party application 1352 (e.g., an application developed using the ANDROID™ or IOS™ software development kit (SDK) by an entity other than the vendor of the particular platform) could be mobile software running on a mobile operating system such as IOS™ , ANDROID™ , WINDOWS® Phone, and/or the like. In this example, the third-party application 1352 can invoke the API calls 1320 provided by the operating system 1312 to facilitate functionality described herein.

In view of the disclosure above, a listing of various examples of embodiments is set forth below. It should be noted that one or more features of an example, taken in isolation or combination, should be considered to be within the disclosure of this application.

Example 1 is a method performed by a computer system executing instructions on at least one hardware processor, the method including: presenting disambiguation data via a user interface; broadcasting one or more advertising packets containing the disambiguation data; establishing a wireless connection with a mobile device, the establishing of the wireless connection with the mobile device including receiving, from the mobile device, at least one message that contains shared-secret data that is based on the disambiguation data; and receiving, from the mobile device via the established wireless connection, a mobile driver's license (mDL) of a user of the mobile device.

Example 2 is the method of Example 1, where the disambiguation data includes a numeric code.

Example 3 is the method of Example 1 or Example 2, where the disambiguation data is a numeric code.

Example 4 is the method of any of the Examples 1-3, where the disambiguation data includes an alphanumeric code.

Example 5 is the method of any of the Examples 1-4, where presenting the disambiguation data via the user interface includes displaying the disambiguation data on a screen of the computer system.

Example 6 is the method of any of the Examples 1-5, further including receiving the disambiguation data via the user interface.

Example 7 is the method of any of the Examples 1-6, where: the computer system resides in a vehicle; and presenting the disambiguation data via the user interface includes displaying the disambiguation data on a screen that is visible outside the vehicle.

Example 8 is the method of any of the Examples 1-7, where: the computer system resides in a vehicle; and presenting the disambiguation data via the user interface includes audibly outputting the disambiguation data such that the disambiguation data is audible outside the vehicle [speaker can be inside or out of the vehicle].

Example 9 is the method of any of the Examples 1-8, where the shared-secret data includes the disambiguation data.

Example 10 is the method of any of the Examples 1-9, where the shared-secret data includes data derived from the disambiguation data.

Example 11 is the method of method of any of the Examples 1-10, where: the computer system resides in a first vehicle; and the mDL is the mDL of a driver of a second vehicle.

Example 12 is a computing system including: at least one hardware processor; and one or more non-transitory computer readable storage media containing instructions that, when executed by the at least one hardware processor, cause the computing system to perform operations including: presenting disambiguation data via a user interface; broadcasting one or more advertising packets containing the disambiguation data; establishing a wireless connection with a mobile device, the establishing of the wireless connection with the mobile device including receiving, from the mobile device, at least one message that contains shared-secret data that is based on the disambiguation data; and receiving, from the mobile device via the established wireless connection, a mobile driver's license (mDL) of a user of the mobile device.

Example 13 is the computing system of Example 12, where the disambiguation data includes a numeric code.

Example 14 is the computing system of Example 12 or Example 13, where the disambiguation data is a numeric code.

Example 15 is the computing system of any of the Examples 12-14, where the disambiguation data includes an alphanumeric code.

Example 16 is the computing system of any of the Examples 12-15, where presenting the disambiguation data via the user interface includes displaying the disambiguation data on a screen of the computer system.

Example 17 is the computing system of any of the Examples 12-16, the operations further including receiving the disambiguation data via the user interface.

Example 18 is the computing system of any of the Examples 12-17, where: the computer system resides in a vehicle; and presenting the disambiguation data via the user interface includes displaying the disambiguation data on a screen that is visible outside the vehicle.

Example 19 is the computing system of any of the Examples 12-18, where: the computer system resides in a vehicle; and presenting the disambiguation data via the user interface includes audibly outputting the disambiguation data such that the disambiguation data is audible outside the vehicle [speaker can be inside or out of the vehicle].

Example 20 is the computing system of any of the Examples 12-19, where the shared-secret data includes the disambiguation data.

Example 21 is the computing system of any of the Examples 12-20, where the shared-secret data includes data derived from the disambiguation data.

Example 22 is the computing system of any of the Examples 12-21, where: the computer system resides in a first vehicle; and the mDL is the mDL of a driver of a second vehicle.

Example 23 is one or more non-transitory computer readable storage media containing instructions that, when executed by at least one hardware processor of a computing system, cause the computing system to perform operations including: presenting disambiguation data via a user interface; broadcasting one or more advertising packets containing the disambiguation data; establishing a wireless connection with a mobile device, the establishing of the wireless connection with the mobile device including receiving, from the mobile device, at least one message that contains shared-secret data that is based on the disambiguation data; and receiving, from the mobile device via the established wireless connection, a mobile driver's license (mDL) of a user of the mobile device.

Further examples include computer readable storage media claims that correspond to the Examples 13-22.

Furthermore, in this disclosure, in one or more embodiments, examples, and/or the like, it may be the case that one or more components of one or more devices, systems, and/or the like are referred to as modules that carry out (e.g., perform, execute, and the like) various functions. With respect to any such usages in the present disclosure, a module includes both hardware and instructions. The hardware could include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more devices and/or components of any other type deemed suitable by those of skill in the art for a given implementation.

In at least one embodiment, the instructions for a given module are executable by the hardware for carrying out the one or more herein-described functions of the module, and could include hardware (e.g., hardwired) instructions, firmware instructions, software instructions, and/or the like, stored in any one or more non-transitory computer-readable storage media deemed suitable by those of skill in the art for a given implementation. Each such non-transitory computer-readable storage medium could be or include memory (e.g., random access memory (RAM), read-only memory (ROM), erasable programmable read-only memory (EPROM), electrically erasable programmable read-only memory (EEPROM a.k.a. E2PROM), flash memory, and/or one or more other types of memory) and/or one or more other types of non-transitory computer-readable storage medium. A module could be realized as a single component or be distributed across multiple components. In some cases, a module may be referred to as a unit.

Moreover, consistent with the fact that the entities and arrangements that are described herein, including the entities and arrangements that are depicted in and described in connection with the drawings, are presented as examples and not by way of limitation, any and all statements or other indications as to what a particular drawing “depicts,” what a particular element or entity in a particular drawing or otherwise mentioned in this disclosure “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively qualified by such a clause. It is for reasons akin to brevity and clarity of presentation that this implied qualifying clause is not repeated ad nauseum in this disclosure.

What is claimed is:

1. A method performed by a computer system executing instructions on at least one hardware processor, the method comprising:
presenting disambiguation data via a user interface;
broadcasting one or more advertising packets containing the disambiguation data;
establishing a wireless connection with a mobile device, the establishing of the wireless connection with the mobile device comprising receiving, from the mobile device, at least one message that contains shared-secret data that is based on the disambiguation data; and
receiving, from the mobile device via the established wireless connection, a mobile driver's license (mDL) of a user of the mobile device.

2. The method of claim 1, wherein the disambiguation data comprises a numeric code.

3. The method of claim 1, wherein the disambiguation data is a numeric code.

4. The method of claim 1, wherein the disambiguation data comprises an alphanumeric code.

5. The method of claim 1, wherein presenting the disambiguation data via the user interface comprises displaying the disambiguation data on a screen of the computer system.

6. The method of claim 1, further comprising receiving the disambiguation data via the user interface.

7. The method of claim 1, wherein:
the computer system resides in a vehicle; and
presenting the disambiguation data via the user interface comprises displaying the disambiguation data on a screen that is visible outside the vehicle.

8. The method of claim 1, wherein:
the computer system resides in a vehicle; and
presenting the disambiguation data via the user interface comprises audibly outputting the disambiguation data such that the disambiguation data is audible outside the vehicle.

9. The method of claim 1, wherein the shared-secret data comprises the disambiguation data.

10. The method of claim 1, wherein the shared-secret data comprises data derived from the disambiguation data.

11. The method of claim 1, wherein:
the computer system resides in a first vehicle; and
the mDL is the mDL of a driver of a second vehicle.

12. A computing system comprising:
at least one hardware processor; and
one or more non-transitory computer readable storage media containing instructions that, when executed by the at least one hardware processor, cause the computing system to perform operations comprising:
presenting disambiguation data via a user interface;
broadcasting one or more advertising packets containing the disambiguation data;
establishing a wireless connection with a mobile device, the establishing of the wireless connection with the mobile device comprising receiving, from the mobile device, at least one message that contains shared-secret data that is based on the disambiguation data; and
receiving, from the mobile device via the established wireless connection, a mobile driver's license (mDL) of a user of the mobile device.

13. The computing system of claim 12, wherein the disambiguation data comprises a numeric code.

14. The computing system of claim 12, wherein the disambiguation data is a numeric code.

15. The computing system of claim 12, wherein the disambiguation data comprises an alphanumeric code.

16. The computing system of claim 12, wherein presenting the disambiguation data via the user interface comprises displaying the disambiguation data on a screen of the computer system.

17. The method of claim 1, the operations further comprising receiving the disambiguation data via the user interface.

18. The computing system of claim 12, wherein:
the computer system resides in a vehicle; and
presenting the disambiguation data via the user interface comprises displaying the disambiguation data on a screen that is visible outside the vehicle.

19. The computing system of claim 12, wherein:
the computer system resides in a vehicle; and
presenting the disambiguation data via the user interface comprises audibly outputting the disambiguation data such that the disambiguation data is audible outside the vehicle.

20. The computing system of claim 12, wherein the shared-secret data comprises the disambiguation data.

21. The computing system of claim 12, wherein the shared-secret data comprises data derived from the disambiguation data.

22. The computing system of claim 12, wherein:
the computer system resides in a first vehicle; and
the mDL is the mDL of a driver of a second vehicle.

23. One or more non-transitory computer readable storage media containing instructions that, when executed by at least one hardware processor of a computing system, cause the computing system to perform operations comprising:
presenting disambiguation data via a user interface;
broadcasting one or more advertising packets containing the disambiguation data;
establishing a wireless connection with a mobile device, the establishing of the wireless connection with the mobile device comprising receiving, from the mobile device, at least one message that contains shared-secret data that is based on the disambiguation data; and
receiving, from the mobile device via the established wireless connection, a mobile driver's license (mDL) of a user of the mobile device.
